(19) United States
(12) Patent Application Publication
(10) Pub. No.: US 2004/0234678 A1
(43) Pub. Date: Nov. 25, 2004

(54) Pattern forming method, pattern forming apparatus, device manufacturing method, conductive film wiring, electro-optical device, and electronic apparatus

(76) Inventors: Toshimitsu Hirai, Chino-shi (JP); Hironori Hasei, Okaya-city (JP)

Correspondence Address: HARNESS, DICKEY & PIERCE, P.L.C., P.O. BOX 828, BLOOMFIELD HILLS, MI, 48303, US

(21) Appl. No.: 10/797,719

(22) Filed: Mar. 10, 2004

(30) Foreign Application Priority Data
Mar. 11, 2003 (JP) 2003-065324
Feb. 6, 2004 (JP) 2004-031049

(51) Int. Cl. B05D 5/12; B05C 5/00

(52) U.S. Cl. 427/58; 427/256; 118/300

(57) ABSTRACT

A pattern forming method is provided for forming line-shaped film patterns W1, W2 by arranging droplets of a liquid material on a substrate, wherein a plurality of pattern forming areas R1, R2 in which the film patterns should be formed are defined on the substrate, a first pattern forming area R1 formed from sides in a line-width direction of the film patterns and a second pattern forming area R2 formed from central portions in the line-width direction of the film patterns are defined from the plurality of pattern forming areas R1, R2, and the droplets are arranged in the first and second pattern forming areas R1, R2, thereby forming the film patterns W1, W2.

### RELATED APPLICATIONS

This application claims priority to Japanese Patent Application Nos. 2003-065324 filed Mar. 11, 2003 and 2004-031049 filed Feb. 6, 2004 which are hereby expressly incorporated by reference herein thier its entireties.

### BACKGROUND

1. Technical Field of the Invention

The present invention relates to a pattern forming method and a pattern forming apparatus for forming a film pattern by arranging droplets of a liquid material on a substrate, a method of manufacturing a device, conductive film wiring, an electro-optical device, and an electronic apparatus.

2. Description of the Related Art

Photolithographic methods have been widely used in methods of manufacturing devices having a fine wiring pattern (film pattern), such as a semiconductor integrated circuit (IC). However, a lot of attention has been paid to a method of manufacturing a device using a droplet discharge method. The droplet discharge method has an advantage that the consumption of a liquid material is less wasteful and the amount or position of the liquid material disposed on the substrate is easily controlled. Techniques concerning a droplet discharge method are disclosed in Japanese Unexamined Patent Application Publication No. 11-274671 and Japanese Unexamined Patent Application Publication No. 2000-216330.

However, the wiring pitch of wiring patterns may be changed variously corresponding to devices to be manufactured. On the other hand, in the droplet discharge method, the droplets are discharged onto a substrate from a droplet discharge head having discharge nozzles arranged with a predetermined pitch. For this reason, even if the wiring pitch of the wiring patterns is changed variously as a designed value, it is required that the wiring patterns be formed with a high throughput by means of one droplet discharge head.

The present invention is contrived to solve the above problem, and it is thus an object of the present invention to provide a pattern forming method, a pattern forming apparatus and a device manufacturing method, whereby when droplets are discharged from a droplet discharge head having a plurality of discharge nozzles to form film patterns, the film patterns can be efficiently formed even if a pattern pitch is changed variously as a designed value. Further, it is another object of the present invention to provide a conductive film wiring with low cost by manufacturing wiring patterns with a high throughput, an electro-optical device, and an electronic apparatus employing the electro-optical device.

### SUMMARY

In order to accomplish the above object, the present invention provides a pattern forming method of forming film patterns by arranging droplets of a liquid material on a substrate, wherein a plurality of pattern forming areas in which the film patterns should be formed are arranged and defined on the substrate, a first pattern forming area in which a film pattern should be formed from a side thereof and a second pattern forming area in which a film pattern should be formed from the center thereof are defined in the plurality of pattern forming areas, and the droplets are arranaged in each of the first and second pattern forming areas to form the film patterns.

According to the present invention, when the film patterns having a predetermined line width are formed by arranging the droplets in each of the plurality of pattern forming areas, the film patterns are formed from one side of the first pattern forming area, and the film patterns are formed from the center of the second pattern forming area. In other words, since the arrangement order (an order of positions in which the portions of the film patterns are formed) of the droplets on the substrate is set to be different in each pattern forming area, the film patterns can be efficiently formed in each of the first and second pattern forming areas even if a pitch of the discharge nozzles of the droplet discharge head is different from a pitch of patterns to be formed. That is, in a case where the nozzle pitch and the pattern pitch are different from each other, if it is intended to arrange the droplets for all the film patterns in the same arrangement order of droplets, the number of discharge nozzles, out of a plurality of discharge nozzles, under a condition (a discharge idle condition, an arrangement idle condition) of not discharging the droplets is increased, thereby causing a low throughput. However, by allowing the arrangement order of droplets to be different in each pattern forming area, that is, by allowing the formation of the film patterns to be started from one side of the first pattern forming area and allowing the formation of the film patterns to be started from the center of the second pattern forming area, the number of discharge nozzles under the discharge idle condition can be decreased even if the nozzle pitch and the pattern pitch are different from each other, so that it is possible to accomplish a high throughput.

The pattern forming method according to the present invention may comprise a step of arranging the droplets substantially simultaneously in the first and second pattern forming areas.

According to the present invention, even if the nozzle pitch and the pattern pitch are different from each other, the positions of the first and second pattern forming areas and the positions of the plurality of discharge nozzles can match by changing the relative positions of the discharge nozzles to the substrate. Therefore, in this state, a high throughput can be accomplished by simultaneously arranging the droplets in each of the first and second pattern forming areas.

The pattern forming method according to the present invention may comprise a step of arranging the droplets in any one of the first and second pattern forming areas.

According to the present invention, even if the nozzle pitch and the pattern pitch are different from each other, the position of any one of the first and second pattern forming areas and the positions of the plurality of discharge nozzles can match by changing the relative positions of the discharge nozzles to the substrate. Therefore, in this state, by arranging the droplets in any one of the first and second pattern forming areas of which the position matches with the positions of the discharge nozzles, the number of discharge nozzles under the discharge idle condition can be suppressed, thereby accomplishing a high throughput.

In the pattern forming method according to the present invention, in the first pattern forming area, the side may be first formed and then the central portion may be formed, and in the second pattern forming area, the central portion may be first formed and then the side may be formed.

According to the present invention, since the arrangement order of droplets is set to be different from each other in each of the first and second pattern forming areas, the number of discharge nozzles under the discharge idle condition can be decreased by arranging the droplets in the first and second pattern forming areas positioned with respect to the discharge nozzles even if the nozzle pitch and the pattern pitch are different from each other, thereby accomplishing a high throughput. Further, by forming the central portions and the sides in each of the first and second pattern forming areas, the wiring patterns having a large width can be formed, so that it is possible to form the film patterns advantageous for electrical conduction.

In the pattern forming method according to the present invention, a plurality of discharge portions for arranging the droplets may be provided corresponding to the first and second pattern forming areas, and the droplets may be arranged while moving the discharge portions in the direction in which the pattern forming areas are arranged.

According to the present invention, since the discharge portions (discharge nozzles) are provided corresponding to the plurality of pattern forming areas and the droplets are arranged while moving the discharge portions, a plurality of film patterns (wiring patterns) can be formed in a short time.

The pattern forming method according to the present invention may comprise a step of forming one side of a first film pattern to be formed in the first pattern forming area; a step of forming a central portion of a second film pattern to be formed in the second pattern forming area at the same time as forming the other side of the first film pattern; and a step of forming any one side of one side and the other side of the second film pattern at the same time as forming a central portion of the first film pattern.

According to the present invention, film patterns having a large width can be efficiently formed in each of the first and second pattern forming areas.

Furthermore, the present invention provides a pattern forming method of forming film patterns by arranging droplets of a liquid material on a substrate, the method comprising, when a plurality of the film patterns are arranged and formed on the substrate: a first step of forming a first area of a first film pattern of the plurality of film patterns; a second step of forming a first area of a second film pattern at the same time as forming a second area of the first film pattern; and a third step of forming a second area of the second film pattern at the same time as forming a third area of the first film pattern.

According to the present invention, since the order of formation positions, that is, the arrangement order of droplets, is set to be different from each other when forming the first film pattern and the second film pattern, the number of discharge nozzles under the discharge idle condition can be suppressed, thereby accomplishing a high throughput.

The pattern forming method according to the present invention may further comprise a fourth step of forming a third area of the second film pattern after the third step.

According to the present invention, each of the first and second film patterns can be formed to have a large width, so that it is possible to form the film patterns advantageous for electrical conduction.

In the pattern forming method according to the present invention, the liquid material comprises conductive particles. As a result, a wiring pattern having conductivity can be formed.

Furthermore, the present invention provides a pattern forming apparatus that comprises a droplet discharge device for arranging droplets of a liquid material on a substrate and that forms film patterns by using the droplets, wherein the droplet discharge device forms a first film pattern to be formed in a first pattern forming area of a plurality of pattern forming areas which are previously arranged on the substrate and in which the film patterns should be formed, from a side thereof, and forms a second film pattern to be formed in a second pattern forming area from a central portion thereof.

Furthermore, the present invention also provides a pattern forming apparatus that comprises a droplet discharge device for arranging droplets of a liquid material on a substrate and that forms a plurality of film patterns on the substrate by using the droplets, wherein the droplet discharge device first forms a first area of a first film pattern, forms a first area of a second film pattern at the same time as forming a second area of the first film pattern, and then forms a second area of the second film pattern at the same time as forming a third area of the first film pattern.

According to the present invention, even if the nozzle pitch and the pattern pitch are different from each other, the number of discharge nozzles under the discharge idle condition can be decreased, thereby accomplishing a high throughput.

Furthermore, the present invention provides a method of manufacturing a device having wiring patterns, the method comprising: a material arranging step of forming the wiring patterns by arranging droplets of a liquid material in each of a plurality of pattern forming areas which are arranged on the substrate and in which the wiring patterns should be formed, wherein in the material arranging step, a first pattern forming area in which a wiring pattern should be formed from one side thereof and a second pattern forming area in which a wiring pattern should be formed from the center thereof are defined in the plurality of pattern forming areas, and the droplets are arranged in each of the first and second pattern forming areas to form the wiring patterns.

Furthermore, the present invention also provides a method of manufacturing a device having a plurallity of wiring patterns, the method comprising a material arranging step of forming the plurality of wiring patterns by arranging droplets of a liquid material on the substrate, wherein the material arranging step comprises: a first step of forming a first area of a first wiring pattern of the plurality of wiring patterns; a second step of forming a first area of a second wiring pattern at the same time as forming a second area of the first wiring pattern; and a third step of forming a second area of the second wiring pattern at the same time as forming a third area of the first wiring pattern.

According to the present invention, even if the nozzle pitch and the pattern pitch are different from each other, the number of discharge nozzles under the discharge idle condition can be decreased, thereby accomplishing a high throughput. Furthermore, since the wiring patterns having a large width can be efficiently formed, it is possible to provide a device having the wiring patterns advantageous for electrical conduction with low cost.

The present invention also provides a conductive film wiring formed using the pattern forming apparatus.

According to the present invention, it is possible to provide conductive film wiring having a large line width and advantageous for electrical conduction with low cost.

The present invention also provides an electro-optical device comprising the aforementioned conductive film wiring. In addition, the present invention also provides an electronic apparatus comprising the aforementioned electro-optical device. According to the present invention, since the electronic apparatus comprises the conductive film wiring advantageous for electrical conduction with low cost, defects such as disconnection or short circuit of a wiring portion, hardly occur.

Here, the electro-optical device may include a plasma display device, a liquid crystal display device, and an organic electroluminescent display device.

The droplet discharge methods of the droplet discharge device (e.g., ink jet device) may include a piezo method of discharging a liquid material by a variation in volume of a piezoelectric element and a method of discharging droplets of a liquid material by rapidly generating vapor-due to applied heat.

The liquid material means a medium having a viscosity that can be discharged through a discharge nozzle of a droplet discharge head (e.g., ink jet head). Whether the liquid material is watery or oily does not matter. Any liquid material may be well used as long as fluidity (viscosity) that can be discharged through a nozzle is given thereto, and any fluid in which a solid material is mixed, may be used as long as it has fluidity as a whole. In addition, a material included in the liquid material may be a material dispersed in a solvent as particles as well as a material heated and melted above a melting point, or a material to which dyes, pigments or other functional materials may be added in addition to a solvent. In addition, the substrate may be a flat substrate or a curved substrate. Further, the hardness of a pattern formation surface need not be large, and the pattern formation surface may be formed of glass or plastics, metal, or a material having flexibility, such as film, paper, or rubber.

### BRIEF DESCRIPTION OF THE DRAWINGS

FIG. 1 is a flowchart illustrating a pattern forming method according to an embodiment of the present invention.

FIGS. 2A-D are mimetic diagrams illustrating the pattern forming method according to the embodiment of the present invention.

FIGS. 3A-C are mimetic diagrams illustrating the pattern forming method according to the embodiment of the present invention.

FIGS. 4A-B are mimetic diagrams illustrating a case where droplets are arranged on a substrate based on predetermined bit map data.

FIGS. 5A-B are mimetic diagrams illustrating a case where droplets are arranged on a substrate based on predetermined bit map data.

FIGS. 6A-B are mimetic diagrams illustrating a case where droplets are arranged on a substrate based on predetermined bit map data.

FIGS. 7A-B are mimetic diagram illustrating a case where droplets are arranged on a substrate based on predetermined bit map data.

FIG. 8 is a mimetic diagram illustrating a case where droplets are arranged on a substrate based on predetermined bit map data according to another embodiment of the present invention.

FIG. 9 is a mimetic diagram illustrating a case where droplets are arranged on a substrate based on predetermined bit map data according to another embodiment of the present invention.

FIG. 10 is a mimetic diagram illustrating a case where droplets are arranged on a substrate based on predetermined bit map data according to another embodiment of the present invention.

FIG. 11 is a mimetic diagram illustrating a case where droplets are arranged on a substrate based on predetermined bit map data according to another embodiment of the present invention.

FIG. 12 is a schematic perspective view illustrating a pattern forming apparatus according to an embodiment of the present invention.

FIG. 13 illustrates an electro-optical device according to an embodiment of the present invention and is an exploded perspective view illustrating an example to which a plasma display device is applied.

FIG. 14 illustrates an electro-optical device according to an embodiment of the present invention and is a plan view perspective view illustrating an example to which a liquid crystal display device is applied.

FIG. 15 shows another embodiment of the liquid crystal display device.

FIGS. 16A-C are views illustrating a field emission display (an FED).

FIG. 17 illustrates an embodiment of an electronic apparatus according to the present invention.

### DETAILED DESCRIPTION

Pattern Forming Method

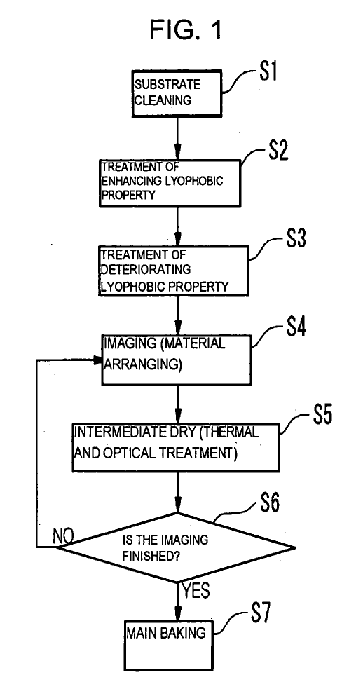

Hereinafter, a pattern forming method according to the present invention will be described with reference to the accompanying drawings. FIG. 1 is a flowchart of a pattern forming method according to an embodiment of the present invention.

Here, in the present embodiment, a case where conductive film wiring pattern is formed on a substrate will be described.

In FIG. 1, the pattern forming method according to the present embodiment comprises a step (step S1) of cleaning a substrate on which droplets of a liquid material are arranged, using a predetermined solvent; a step (step S2) of performing lyophobic treatment that constitutes a part of a surface treatment step of the substrate; a step (step S3) of performing lyophobic property lowering treatment that constitutes a part of the surface treatment step of adjusting a lyophobic property of the surface of the substrate on which lyophobic treatment is performed; a material arrangement step (step S4) of arranging droplets of the liquid material including a material for forming a conductive film wiring, on the substrate on which the surface treatment step is performed, based on a droplet discharge method and drawing (forming) a film pattern; an intermediate drying step (step S5) including heat/light treatment for removing at least a part of a solvent component of the liquid material arranged on the substrate; and a baking step (step S7) of baking the substrate on which a predetermined film pattern is drawn. In addition, the pattern forming method further comprises a step (step S6) of determining whether a predetermined pattern drawing has been completed after the intermediate drying step, and if the pattern drawing has been completed, the baking step is performed, and if the pattern drawing has not been completed, the material arrangement step is repeated.

Next, the material arranging step (step S4) based on the droplet discharge method will be described, which is a part of the present invention.

The material arrangement step according to the present embodiment is a step of discharging droplets of a liquid material including a material for forming a conductive film wiring onto a substrate from a droplet discharge head of a droplet discharge device so that a plurality of linear film patterns (wiring pattern) can be formed in parallel on the substrate. The liquid material is a liquid material in which conductive particles, such as metal, as the material for forming the conductive film wiring are dispersed in a dispersion medium. In the below description, it will be described about a case that two first and second film patterns W1 and W2 are formed on the substrate 11.

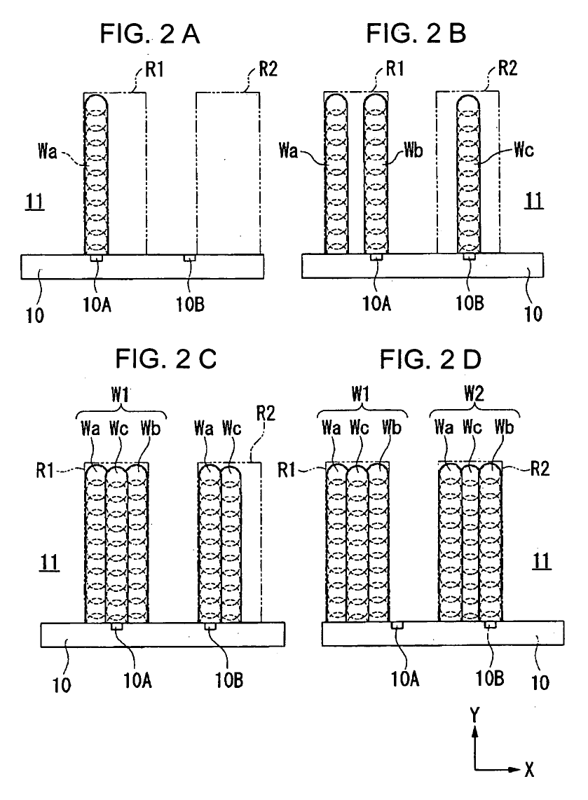

In FIGS. 2A-D, in the material arranging step (step S4), first, a first pattern forming area R1 and a second pattern forming area R2 in which a first film pattern W1 and a second film pattern W2 should be formed are arranged and defined on the substrate 11. Then, in the first pattern forming area R1, the first film pattern W1 to be formed in the first pattern forming area R1 is formed from one side of the line-width direction, and in the second pattern forming area R2, the second film pattern W2 to be formed in the second pattern forming area R2 is formed from a central portion of the line-width direction.

In the first pattern forming area R1 on the substrate 11, the droplets of a liquid material discharged from a first discharge nozzle 10A of a plurality of discharge nozzles provided in a droplet discharge head 10 of a droplet discharge device are arranged. On the other hand, in the second pattern forming area R2 on the substrate 11, the droplets of the liquid material discharged from a second discharge nozzle 10B other than the first discharge nozzle 10A are arranged. That is, the discharge nozzles (discharge portions) 10A, 10B are provided to correspond to the first and second pattern forming areas R1, R2, respectively.

First, as shown in FIG. 2(a), a first side pattern Wa that is one side of the line-width direction of the first film pattern W1 to be formed in the first pattern forming area R1 is formed out of the droplets discharged from the discharge nozzle 10A. The droplets of the liquid material discharged from the discharge nozzle 10A of the droplet discharge head 10 are arranged on the substrate 11 with a constant distance gap (pitch). Then, by repeating the arrangement of the droplets, the first side pattern Wa of a line shape constituting a part of the film pattern W1 is formed at the one side of the pattern forming area R1 for the film pattern W1.

In this way, in FIG. 2(a), the droplets are arranged only in the first pattern forming area R1.

In addition, since the surface of the substrate 11 is previously treated to have a desired lyophobic property by steps S2 and S3, the spread of the droplets arranged on the substrate 11 is suppressed. Therefore, a pattern shape can be surely controlled in a good state, and the thickness of a thin film can be easily increased.

Here, after droplets to form the first side pattern Wa are arranged on the substrate 11, in order to remove a dispersion medium, intermediate drying (step S5) is performed, if necessary. The intermediate drying may be light treatment using lamp annealing other than general heat treatment using a heating apparatus, such as a hot plate, an electric furnace, or a hot blast generator.

Next, as shown in FIG. 2(b), the droplet discharge head 10 and the substrate 11 are relatively moved in the direction in which the first and second pattern forming areas R1, R2 are arranged, that is, in an X axis direction. Here, the droplet discharge head 10 is stepwise moved in the +X direction. As a result, the discharge nozzles 10A, 10B are moved in the X-axis direction. Then, as shown in FIG. 2(b), a second side pattern Wb that is the other side of the line-width direction of the first film pattern W1 to be formed in the first pattern forming area R1 is formed out of the droplets discharged from the discharge nozzle 10A. The droplets of the liquid material discharged from the discharge nozzle 10A of the droplet discharge head 10 are arranged on the substrate 11 with a constant distance gap (pitch). Then, by repeating the arrangement action of the droplets, the second side pattern Wb of a line shape constituting a part of the film pattern W1 is formed at the other side of the first pattern forming area R1 for the film pattern W1.

At the same time as forming the second side pattern, a central pattern. Wc that is a central portion of the line-width direction of the second film pattern W2 to be formed in the second pattern forming area R2 is formed out of the droplets discharged from the discharge nozzle 10B. The droplets of the liquid material discharged from the discharge nozzle 10B of the droplet discharge head 10 are arranged on the substrate 11 with a constant distance gap (pitch). Then, by repeating the arrangement action of the droplets, the central pattern Wc of a line shape constituting a part of the film pattern W2 is formed at the center of the second pattern forming area R2. In this way, in FIG. 2(b), the droplets are simultaneously arranged in the first and second pattern forming areas R1, R2.

Here, after the droplets to form the second side pattern Wb of the first pattern forming region R1 and the central pattern Wc of the second pattern forming region R2 are arranged on the substrate 11, in order to remove a dispersion medium, intermediate drying can be performed, if necessary.

Next, as shown in FIG. 2(c), the droplet discharge head 10 is stepwise moved in the −X direction.

Accordingly, the discharge nozzles 10A, 10B are moved in the −X direction. Then, as shown in FIG. 2(c), a central pattern Wc that is a central portion of the line-width direction of the first film pattern W1 to be formed in the first pattern forming area R1 is formed out of the droplets discharged from the discharge nozzle 10A. The droplets of the liquid material discharged from the discharge nozzle 10A of the droplet discharge head 10 are arranged on the substrate 11 with a constant distance gap (pitch). Then, by repeating the arrangement action of the droplets, the central pattern Wc of a line shape is formed at the center of the first pattern forming area R1. By arranging the droplets for forming the central pattern Wc, a concave portion between the first side pattern Wa and the second side pattern Wb is filled with the droplets (the liquid material), whereby the first side pattern Wa and the second-side pattern Wb forms a body to form the first film pattern W1.

At the same time, a first side pattern Wa that is one side of the line-width direction of the second film pattern W2 to be formed in the second pattern forming area R2 is formed out of the droplets discharged from the discharge nozzle 10B. The droplets of the liquid material discharged from the discharge nozzle 10B of the droplet discharge head 10 are arranged on the substrate 11 with a constant distance gap (pitch). Then, by repeating the arrangement action of the droplets, the first side pattern Wa of a line shape is formed at the central portion of the second pattern forming area R2. In this way, in FIG. 2(c), the droplets are simultaneously arranged in the first and second pattern forming areas R1, R2.

Here, when the first side pattern Wa of a line shape adjacent to one side of the central pattern Wc is formed, the droplets are arranged such that at least a part of the discharged droplets and the central pattern Wc formed on the substrate 11 is superposed. As a result, the central pattern Wc and the droplets for forming the first side pattern Wa are surely connected, so that discontinuous portions of the material for forming the conductive film are not generated in the formed film pattern W2.

Here, after the droplets to form the central pattern Wc of the first pattern forming region R1 and the first side pattern Wa of the second pattern forming region R2 are arranged on the substrate 11, in order to remove a dispersion medium, intermediate drying can be performed, if necessary.

Next, as shown in FIG. 2(d), the droplet discharge head 10 is stepwise moved in the +X direction.

Accordingly, the discharge nozzles 10A, 10B are moved in the −X direction. Then, as shown in FIG. 2(d), a second side pattern Wb that is the other side of the line-width direction of the second film pattern W2 to be formed in the second pattern forming area R2 is formed out of the droplets discharged from the discharge nozzle 10B. The droplets of the liquid material discharged from the discharge nozzle 10B of the droplet discharge head 10 are arranged on the substrate 11 with a constant distance gap (pitch). Then, by repeating the arrangement action of the droplets, the second side pattern Wb of a line shape constituting a part of the film pattern W2 is formed at the other side of the second pattern forming area R2 for the film, pattern W2. In this way, in FIG. 2(d), the droplets are arranged only in the second pattern forming area R2.

Here, when the second side pattern Wb of a line shape adjacent to the other side of the central pattern Wc is formed, the droplets are arranged such that at least a part of the discharged droplets and the central pattern Wc formed on the substrate 11 is superposed. As a result, the central pattern Wc and the droplets for forming the second side pattern Wb are surely connected, so that discontinuous portions of the material for forming the conductive film are not generated in the formed film pattern W2. In this way, in the second pattern forming area R2, the central pattern Wc and the first and second side patterns Wa, Wb forms a body to form a second film pattern W2 having a large width.

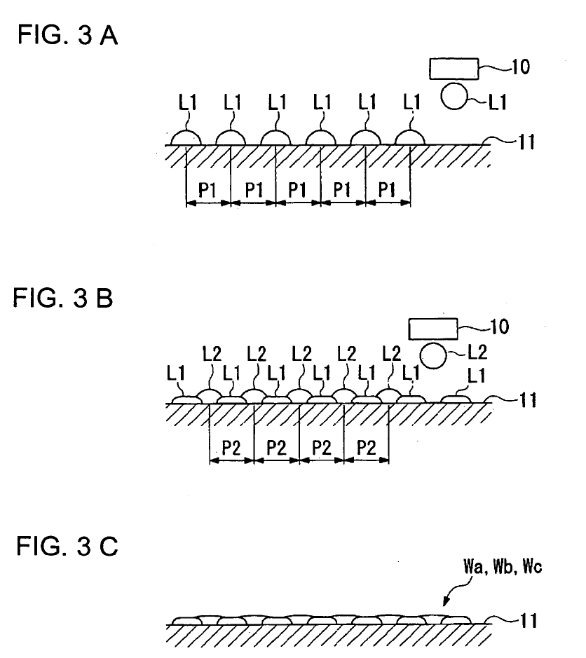

Next, a method of forming a linear central pattern Wc and side patterns Wa and Wb will be described with reference to FIGS. 3(a) to 3(c).

First, as shown in FIG. 3(a), droplets L1 discharged through a droplet discharge head 10 are sequentially arranged on a substrate 11 at predetermined gaps. In other words, the droplet discharge head 10 arranges the droplets L1 on the substrate 11 so as not to overlap with one another. In the present embodiment, an arrangement pitch P1 of the droplets L1 is set to be larger than the diameter of the droplets L1 immediately after being arranged on the substrate 11. As a result, the droplets L1 immediately after being arranged on the substrate 11 are prevented from-overlapping with one another (from contacting one another), and the droplets L1 are combined with one another and are prevented from getting wet and spreading on the substrate 11. In addition, the arrangement pitch P1 of the droplet L1 is set to be less than twice the diameters of the droplet L1 immediately after being arranged on the substrate 11.

Here, after the droplets L1 are arranged on the substrate 11, in order to remove a dispersion medium, intermediate drying (step S5) may be performed, if necessary. As described above, the intermediate drying, may be light treatment using lamp annealing other than general heat treatment using a heating apparatus, such as a hot plate, an electric furnace, and a hot blast generator.

Next, as shown in FIG. 3(b), the arrangement operation of the above-described droplets is repeatedly performed. In other words, as in the previous step as shown in FIG. 3(a), the liquid material is discharged as droplets L2 from the droplet discharge head 10, and the droplets L2 are arranged on the substrate 11 at predetermined gaps. In this case, the volume of the droplets L2 (the amount of the liquid material per one droplet) and an arrangement pitch P2 thereof are the same as those of the previous droplets L1. The arrangement position of the droplets L2 is shifted by a ½ pitch from the previous droplets L1, and the droplets L2 are arranged at intermediate positions relative to the previous droplets L1 arranged on the substrate 11.

As described above, the arrangement pitch P1 of the droplets L1 on the substrate 11 is larger than the diameter of the droplets L1 immediately after being arranged on the substrate 11 and is less than twice the diameter. Therefore, the droplets L2 are arranged in the intermediate position of the droplets L1 so that parts of the droplets L2 overlaps with the droplets L1, and a gap between the droplets L1 is filled with the overlapped droplets L2. In this case, the present droplets L2 and the previous droplets L1 contact one another. However, since the dispersion medium in the droplets L1 is completely or somewhat removed, there is little probability that the previous droplets and the present droplets are combined with one another and are spread on the substrate 11.

In addition, in FIG. 3(b), a position in which the arrangement of the droplets L2 begins, is at the same side (left side of FIG. 3(a)) as that of the previous step, but may be at a reverse side (right side). Discharge of droplets is performed during movement in each direction of a reciprocating operation so that the distance of movement of the droplet discharge head 10 relative to the substrate 11 can be reduced.

After the droplets L2 are arranged on the substrate 11, in order to remove the dispersion medium, as in the previous step, intermediate drying can be performed, if necessary.

A series of such arrangement operations of droplets are repeatedly performed so that a gap between the droplets arranged on the substrate 11 is filled, and as shown in FIG. 3(c), linear and continuous central pattern Wc and side patterns Wa and Wb are formed on the substrate 11. In this case, the number of repetitions of the arrangement operation of the droplets is increased so that the droplets sequentially overlap with one another on the substrate 11, and the layer thickness of the linear patterns Wa, Wb, and Wc, that is, the height (thickness) of the patterns from the surface of the substrate 11 is increased.

The height (thickness) of the linear patterns Wa, Wb, and Wc is set according to a desired layer thickness required in a final film pattern, and the number of repetitions of the arrangement operation of the droplets is set according to the set layer thickness.

In addition, the method of forming linear patterns is not limited to those shown in FIGS. 3(a) to 3(c).

For example, the arrangement pitch of droplets or the amount of shifting during repetition can be set arbitrarily, and the arrangement pitch on a substrate P of droplets when forming the patterns Wa, Wb, and Wc may be set to different values. For example, when the pitch of the droplets when forming the central pattern Wc is P1, the pitch of the droplets when forming the side patterns Wa and Wb may be a pitch larger than P1. Of course, the pitch may be a pitch smaller than P1. In addition, the volume of the droplets when forming the patterns Wa, Wb, and Wc may be set to different values. As an alternative, a droplet discharge atmosphere (temperature or humidity) that is an atmosphere in which the substrate 11 or the droplet discharge head 10 is arranged in each of the first, second, and third steps, that is, the droplet arrangement atmosphere may be set differently

In addition, in the present embodiment, the plurality of side patterns Wa and Wb may be formed one by one or two side patterns may be simultaneously formed. Here, since the sum of the number of times of performing drying in a case where the plurality of side patterns Wa and Wb are formed one by one may be different from that in a case where two side patterns are simultaneously formed, drying conditions may be set not to damage the lyophobic property of the substrate 11.

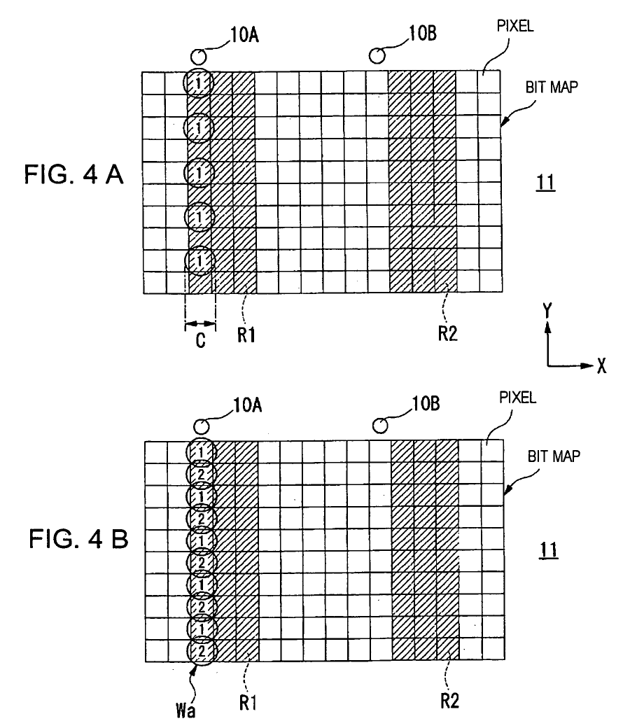

Next, a method of discharging droplets on a substrate will be described with reference to FIGS. 4 to 7. As shown in FIGS. 4 to 7, a bit map having pixels which are a plurality of lattice-like unit areas in which droplets of a liquid material are discharged, is set on the substrate 11. The droplet discharge head 10 discharges droplets to a position of the pixels set as the bit map. Here, one pixel is set to be square. In addition, the droplet discharge head 10 discharges the droplets to the substrate 11 from the discharge nozzle 10A and 10B while scanning in a Y-axis direction. In the description with reference to FIGS. 4 to 7, “1” is given to the droplets discharged during first scanning, and “2”, “3”, . . . , and “n” are given to the droplets discharged during second, third, . . . , and n-th scanning.

In the following description, the first and second film patterns W1 and W2 are formed by arranging the droplets in the respective areas (the first and second pattern forming areas R1 and R2) denoted by a gray color in FIG. 4.

As shown in FIG. 4(a), during the first scanning, in order to form the first side pattern Wa of the first pattern forming region R1, the droplets are discharged through the first discharge nozzle 10A by opening one pixel in a region in which the first side pattern is to be formed. Here, the droplets discharged to the substrate 11 land on the substrate 11 so that the droplets spread on the substrate 11. In other words, as shown in a circle of FIG. 4(a), the droplets landing on the substrate 11 spread to have a diameter c larger than the distance of one pixel. Here, since the droplets are discharged at predetermined intervals (one pixel) in the Y-axis direction, the droplets arranged on the substrate 11 are set not to overlap with one another. Thus, the liquid material is prevented from being excessively formed on the substrate 11 in the Y-axis direction, and the occurrence of bulging can be prevented.

In addition, in FIG. 4(a), the droplets are arranged on the substrate 11 not to overlap with one another, but the droplets may be arranged to slightly overlap with one another. In addition, the droplets are discharged by opening one pixel, but the droplets may be discharged by opening intervals of two or more pixels. In this case, the number of scanning and discharge operations of the droplet discharge head 10 on the substrate 11 is increased so that an interval between the droplets on the substrate is interpolated (filled).

Here, in the state shown in FIG. 4, since the second discharge nozzle 10B is located at a position spaced from the second pattern forming area R2, the droplets are not discharged from the second discharge nozzle 10B. That is, in the state shown in FIG. 4, the second discharge nozzle 10B is under the discharge idle condition.

FIG. 4(b) is a mimetic diagram showing a case where droplets are discharged to the substrate 11 from the droplet discharge head 10 by second scanning. In addition, in FIG. 4(b), “2” is given to the droplets discharged during the second scanning. During the second scanning, the droplets are discharged through the first discharge nozzle 10A to interpolate (fill) an interval between the droplets “1” discharged during the first scanning. By performing the first and second scanning and discharge operations, the droplets are continuously discharged (aligned), and the first side pattern (first region) Wa of the first film pattern W1 is formed (first step).

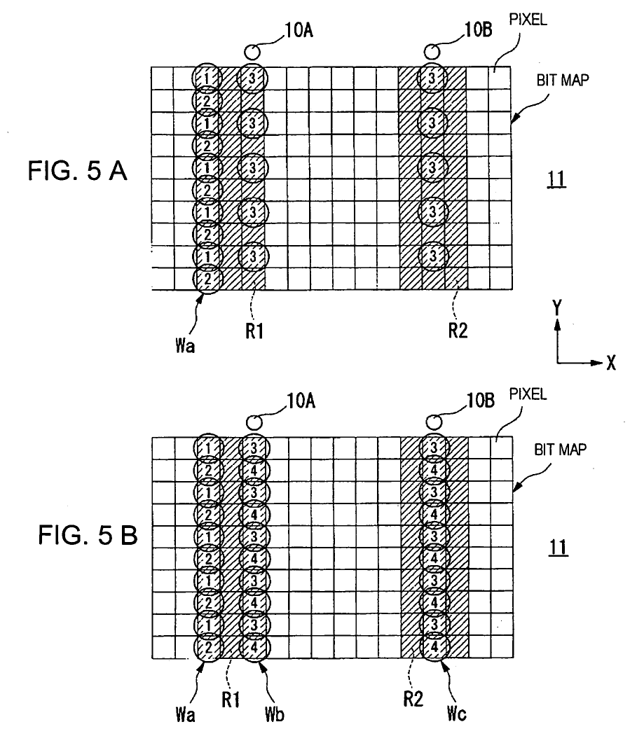

Next, the droplet discharge head 10 is moved relative to the substrate 11 in an X-axis direction by the distance of two pixels. Here, the droplet discharge head 10 makes a stepwise movement with respect to the substrate 11 in the +X-axis direction by the distance of two pixels. In addition, the discharge nozzles 10A and 10B are moved. Then, the droplet discharge head 10 performs third scanning. As a result, as shown in FIG. 5(a), the droplets “3” to form the second side pattern Wb constituting part of the first film pattern W1 are arranged on the substrate 11 to be adjacent to an X-axis with relation to the first side pattern Wa, through the first discharge nozzles 10A. Here, the droplets “3” are arranged by opening one pixel in the Y-axis direction. At the same time, the droplets “3” to form the central pattern Wc constituting part of the second film pattern W2 are arranged on the central pattern forming prearrangement region of the second pattern forming region R2 of the substrate 11, through the second discharge nozzles 10B. Here, the droplets “3” are arranged by opening one pixel in the Y-axis direction.

FIG. 5(b) is a mimetic diagram showing a case where droplets are discharged to the substrate 11 from the droplet discharge head 10 by fourth scanning. In addition, in FIG. 5(b), “4” is given to the droplets discharged during the fourth scanning. During the fourth scanning, the droplets are discharged through the first and second discharge nozzles 10A and 10B to interpolate (fill) an interval between the droplets “3” discharged during the third scanning. Then, by performing the third and fourth scanning and discharge operations, the droplets are continuously discharged (aligned). The second side pattern (second region) Wb of the first film pattern W1 is formed and the central pattern (first region) Wc of the second film pattern W2 is formed (second step).

Next, the droplet discharge head 10 is stepwise moved by one pixel in the −X direction with respect to the substrate, and the discharge nozzles 10A, 10B are thus moved by one pixel in the −X direction. Then, the droplet discharge head 10 carries out the fifth scanning. Accordingly, as shown in FIG. (6a), the droplets “5” for forming the central pattern Wc constituting a part of the first film pattern W1 are arranged on the substrate. Here, the droplets “5” are arranged with an interval corresponding to one pixel in the Y-axis direction. At the same time, the droplets “5” for forming the first side pattern Wa constituting a part of the second film pattern W2 are arranged in the first side pattern forming area in the second pattern forming area R2 on the substrate 11 from the second discharge nozzle 10B. Here, the droplets “5” are arranged with an interval corresponding to one pixel in the Y-axis direction.

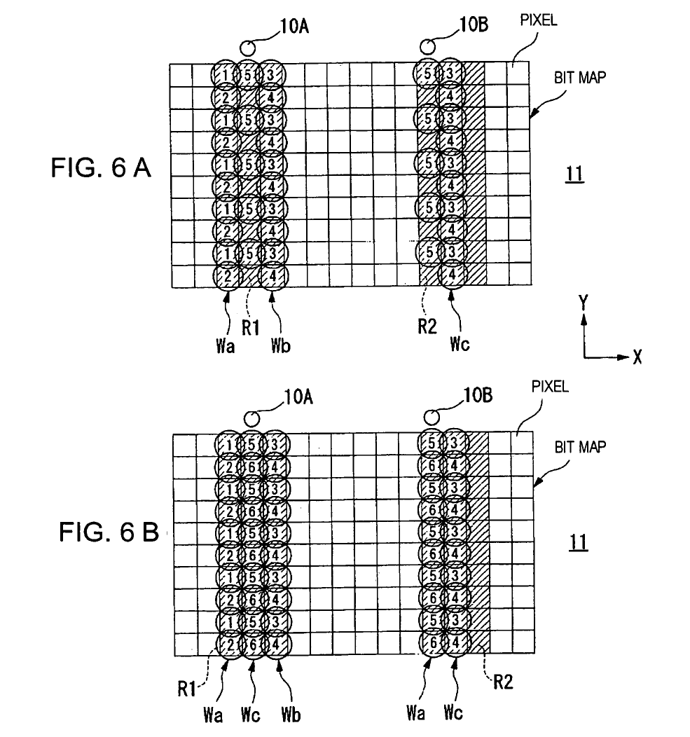

FIG. 6(b) is a mimetic diagram showing a case where droplets are discharged to the substrate 11 from the droplet discharge head 10 by sixth scanning. In addition, in FIG. 6(b), “6” is given to the droplets discharged during the sixth scanning. During the sixth scanning, the droplets are discharged through the first and second discharge nozzles 10A and 10B to interpolate (fill) an interval between the droplets “5” discharged during the fifth scanning. Then, by performing the fifth and sixth scanning and discharge operations, the droplets are continuously discharged. The central pattern (third region) Wc of the first film pattern W1 is formed and the first side pattern (second region) Wa of the second film pattern W2 is formed (third step).

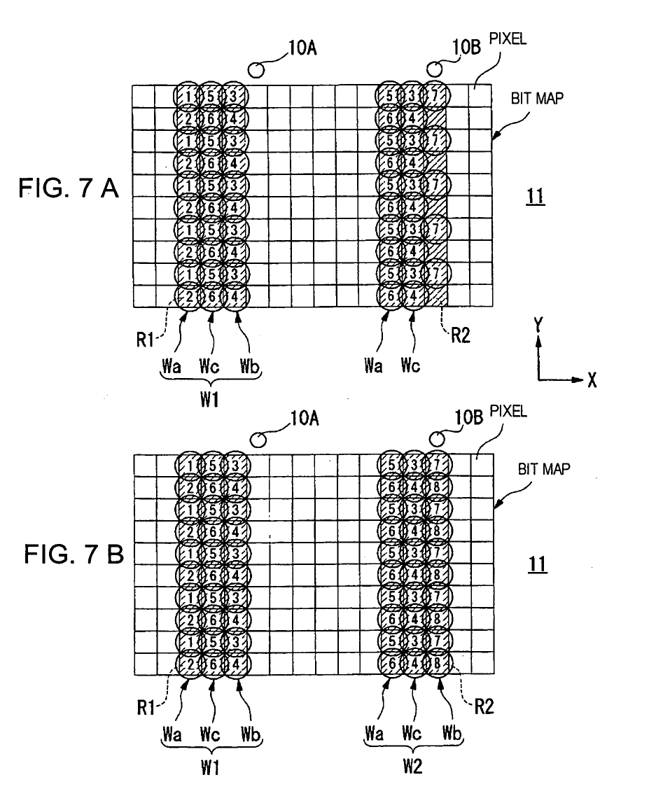

Next, the droplet discharge head 10 is stepwise moved by two pixels in the +X direction with respect to the substrate, and the discharge nozzles 10A, 10B are thus moved by two pixels in the +X direction. Then, the droplet discharge head 10 carries out the seventh scanning. Accordingly, as shown in FIG. 7(a), the droplets “7” for forming the second side pattern Wb constituting a part of the second film pattern W2 are arranged on the substrate. Here, the droplets “7” are arranged with an interval corresponding to one pixel in the Y-axis direction. At that time, since the first film pattern W1 is completely formed and the first discharge nozzle 10A is located at a position departing from the first pattern forming area R1, the droplets are not discharged from the first discharge nozzle 10A. That is, in the state shown in FIG. 7, the first discharge nozzle 10A is under the discharge idle condition.

FIG. 7(b) is a mimetic diagram showing a case where droplets are discharged to the substrate 11 from the droplet discharge head 10 by eighth scanning. In addition, in FIG. 7(b), “8” is given to the droplets discharged during the eighth scanning. During the eighth scanning, the droplets are discharged through the second discharge nozzle 10B to interpolate an interval between the droplets “7” discharged during the seventh scanning. In addition, the first discharge nozzle 10A is under the discharge idle condition. Then, by performing the seventh and eighth scanning and discharge operations, the droplets are continuously discharged, and the second side pattern (third region) Wb of the second film pattern W2 is formed (fourth step).

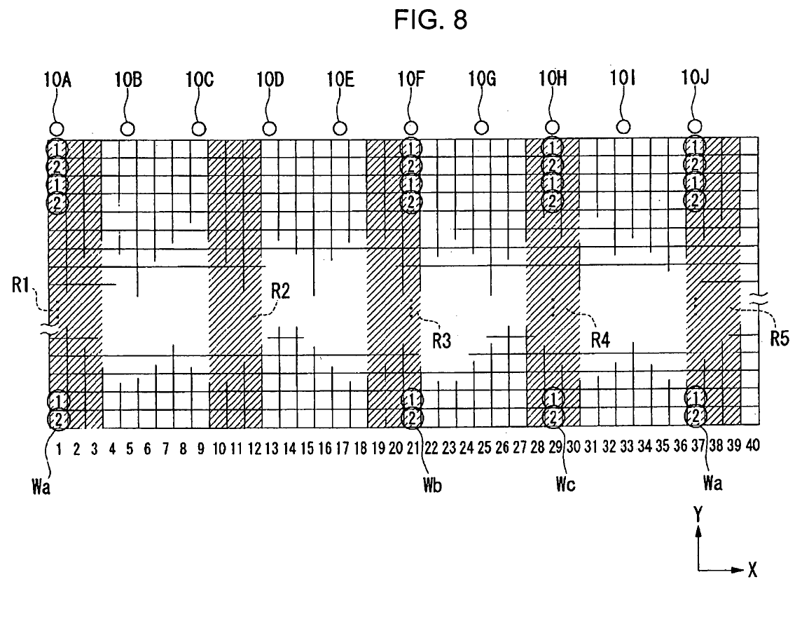

Next, another embodiment of the pattern forming method will be described with reference to FIGS. 8 to 11. Here, ten discharge nozzles 10A to 10J are provided, and the nozzle pitch is set to correspond to four pixels. In other words, the number of lattices corresponding to one discharge nozzle in the X-axis direction is four. That is, a range (that is, an area where a pattern can be formed by using one discharge nozzle) where one discharge nozzle can arrange the droplets on the substrate corresponds to four pixels (four column) in the X-axis direction. For example, the first discharge nozzle 10A can arrange the droplets within a range of pixels in the first through fourth columns in FIG. 8, and the second discharge nozzle 10B can arrange the droplets within a range of pixels in the fifth through eighth columns. Similarly, the discharge nozzle 10C can arrange the droplets within a range of pixels in the ninth through twelfth columns, the discharge nozzle 10D can arrange the droplets within a range of pixels in the thirteenth through sixteenth columns, . . . , the discharge nozzle 10H can arrange the droplets within a range of pixels in the twenty-ninth through thirty-second columns, the discharge nozzle 101 can arrange the droplets within a range of pixels in the thirty-third through thirty-sixth columns, and the discharge nozzle 10J can arrange the droplets within a range of pixels in the thirty-seventh through fortieth columns. In this embodiment, the wiring patterns (film patterns) W1 through W5 having a line width corresponding to three pixels as a designed value are formed with a wiring pitch corresponding to six pixels. That is, the pattern forming areas R1 through R5 for the wiring patterns are defined as the areas denoted by a gray color in FIG. 8. Therefore, in this embodiment, the droplets discharged from the first discharge nozzle 10A are arranged in the first pattern forming area R1, the droplets discharged from the third discharge nozzle 10C are arranged in the second pattern forming area R2, the droplets discharged from the sixth discharge nozzle 10F are arranged in the third pattern forming area R3, the droplets discharged from the eighth discharge nozzle 10H are arranged in the fourth pattern forming area R4, and the droplets discharged from the tenth discharge nozzle 10J are arranged in the fifth pattern forming area R5.

In FIG. 8, the discharge nozzle 10A is positioned with respect to the pattern forming area R1, the discharge nozzle 10F is positioned with respect to the pattern forming area R3, the discharge nozzle 10H is positioned with respect to the pattern forming area R4, and the discharge nozzle 10J is positioned with respect to the pattern forming area R5. Therefore, the droplets can be arranged in the pattern forming areas R1, R3, R4, and R5. On the other hand, no discharge nozzle is positioned with respect to the pattern forming area R2. Therefore, the pattern forming area R2 is under the arrangement idle condition of droplets.

Then, in the same order as described with reference to FIGS. 4 through 7, the droplet discharge head 10 scans the substrate 11, so that the droplets are discharged from the discharge nozzles 10A, 10F, 10H, 10J. By means of the first and second scans, the droplets are arranged as indicated by “1” and “2” in FIG. 8. As a result, the first side pattern Wa is formed in the pattern forming area R1, the second side pattern Wb is formed in the pattern forming area R3, the central pattern Wc is formed in the pattern forming area R4, and the first side pattern Wa is formed in the pattern forming area R5.

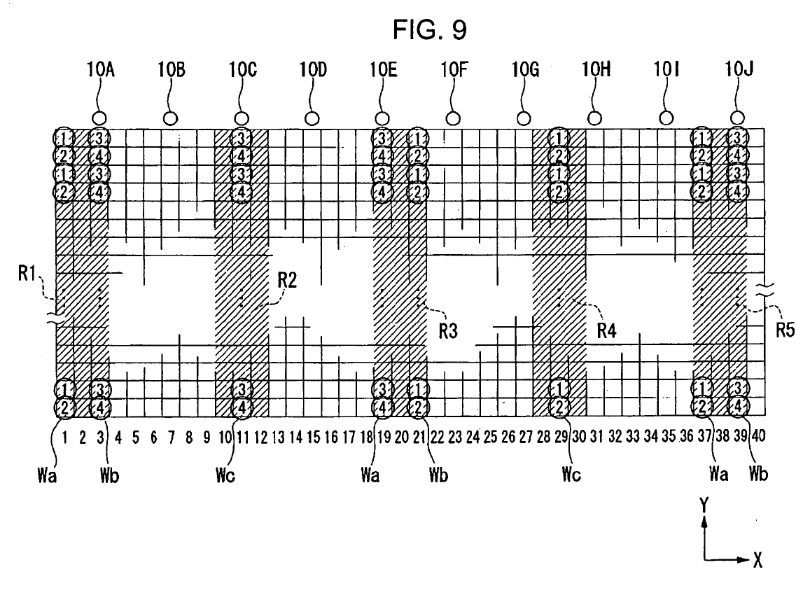

Next, as shown in FIG. 9, the droplet discharge head 10 is stepwise moved by two pixels in the +X direction, and the discharge nozzles 10A through 10J are accordingly moved. In FIG. 9, the discharge nozzle 10A is positioned with respect to the pattern forming area R1, the discharge nozzle 10C is positioned with respect to the pattern forming area R2, the discharge nozzle 10E is positioned with respect to the pattern forming area R3, and the discharge nozzle 10J is positioned with respect to the pattern forming area R5. As a result, the droplets can be arranged in the pattern forming areas R1, R2, R3, and R5. On the other hand, no discharge nozzle is positioned with respect to the pattern forming area R4. Therefore, the pattern forming area R4 is in the arrangement idle condition.

Then, the droplet discharge head 10 scans the substrate 11, so that the droplets are discharged from the discharge nozzles 10A, 10C, 10E, and 10J. By means of the third and fourth scans, the droplets are arranged as indicated by “3” and “4” in FIG. 8. As a result, the second side pattern Wb is formed in the pattern forming area R1, the central pattern Wc is formed in the pattern forming area R2, the first side pattern Wa is formed in the pattern forming area R3, and the second side pattern Wb is formed in the pattern forming area R5.

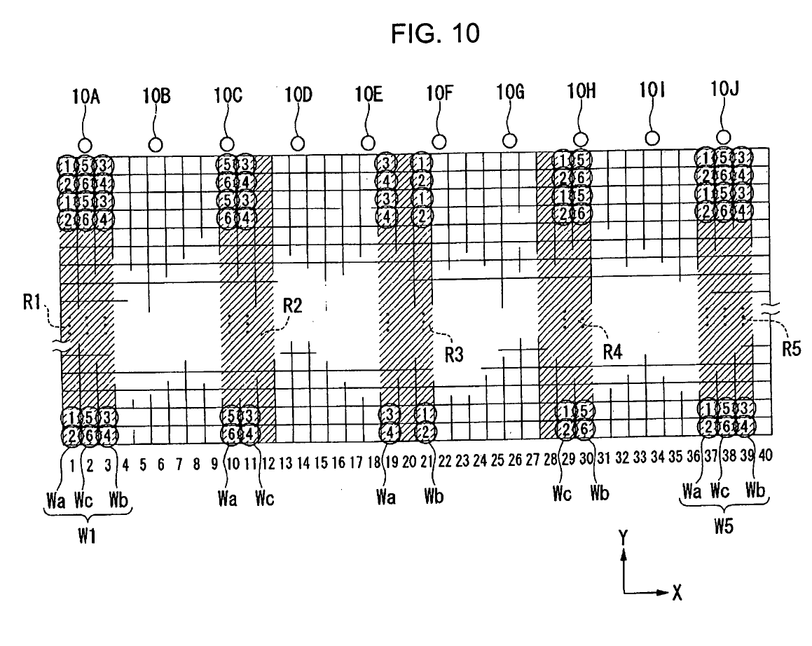

Next, as shown in FIG. 10, the droplet discharge head 10 is stepwise moved by one pixel in the −X direction, and the discharge nozzles 10A through 10J are accordingly moved. In FIG. 10, the discharge nozzle 10A is positioned with respect to the pattern forming area R1, the discharge nozzle 10C is positioned with respect to the pattern forming area. R2, the discharge nozzle 10H is positioned with respect to the pattern forming area R4, and the discharge nozzle 10J is positioned with respect to the pattern forming area R5. Therefore, the droplets can be arranged in the pattern forming areas R1, R2, R4, and R5. On the other hand, no discharge nozzle is positioned with respect to the pattern forming area R3. Therefore, the pattern forming area R3 is in the arrangement idle condition.

Then, the droplet discharge head 10 scans the substrate 11, so that the droplets are discharged from the discharge nozzles 10A, 10C, 10H, and 10J. By means of the fifth and sixth scans, the droplets are arranged as indicated by “5” and “6” in FIG. 10. As a result, the central pattern Wc is formed in the pattern forming area R1, the first side pattern Wa is formed in the pattern forming area R2, the second side pattern Wb is formed in the pattern forming area R4, and the central pattern Wc is formed in the pattern forming area R5.

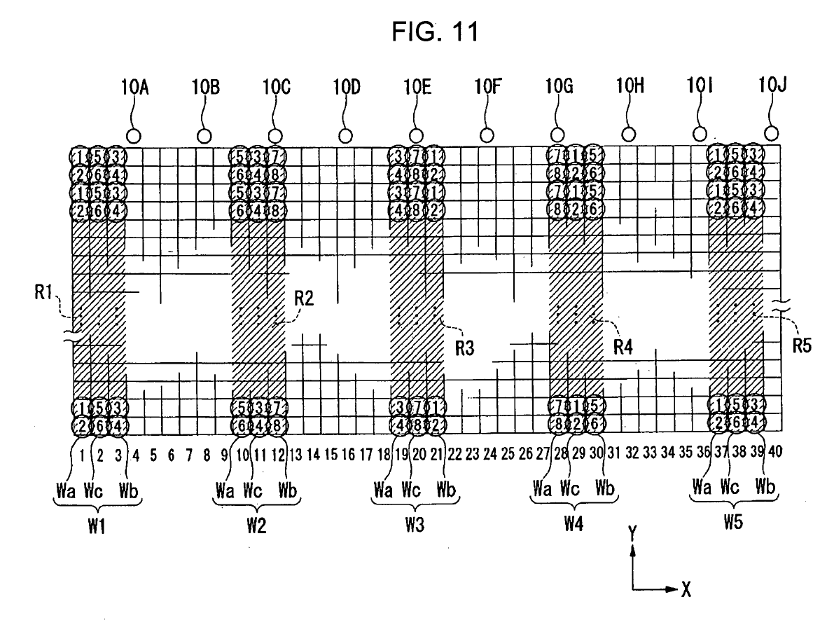

Next, as shown in FIG. 11, the droplet discharge head 10 is stepwise moved by two pixels in the +X direction, and the discharge nozzles 10A through 10J are accordingly moved. In FIG. 11, the discharge nozzle 10C is positioned with respect to the pattern forming area R2, the discharge nozzle 10E is positioned with respect to the pattern forming area R3, and the discharge nozzle 10G is positioned with respect to the pattern forming area R4. As a result, the droplets can be arranged in the pattern forming areas R2, R3, R4. On the other hand, no discharge nozzle is positioned with respect to the pattern forming areas R1, R5. Therefore, the pattern forming areas R1, R5 are in the arrangement idle condition. Furthermore, in this state, the film patterns W1, W5 in the pattern forming areas R1, R5 are completely formed.

Then, the droplet discharge head 10 scans the substrate 11, so that the droplets are discharged from the discharge nozzles 10C, 10E, and 10G. By means of the seventh and eighth scans, the droplets are arranged as indicated by “7” and “8” in FIG. 11. As a result, the second side pattern Wb is formed in the pattern forming area R2, the central pattern Wc is formed in the pattern forming area R3, and the first side pattern Wa is formed in the pattern forming area R4.

In this way, the first through fifth film patterns W1 through W5 are formed. As in this embodiment, even when the discharge nozzle pitch and the wiring pattern pitch are not equal to each other, by applying the pattern forming method according to the present invention, the pattern forming area which is in the arrangement idle condition in each scan can be limited to, for example, one, as described with reference to FIGS. 8 through 11. Therefore, a plurality of film patterns can be efficiently formed in a short time (by means of eight scans in this embodiment).

In addition, in the present embodiment, a variety of materials, such as a glass, a quartz glass, a Si wafer, a plastic film, and a metallic plate may be used as a substrate for conductive film wiring. In addition, a semiconductor film, a metallic film, a dielectric film, or an organic film may be formed as a base layer on the surface of the substrate formed of the variety of materials.

In the present embodiment, a dispersion solution (liquid material), in which conductive particles are dispersed in a dispersion medium, is used as the liquid material for conductive film wiring, and it does not matter whether the dispersion solution is watery or oily. Here, particles, such as conductive polymer or superconductor, other than metallic particles containing any one of gold, silver, copper, palladium, and nickel, are used as the conductive particles. In order to improve dispersibility, organic materials are coated on the surface of the conductive particles, and the coated organic materials may be used as the conductive particles. For example, an organic solvent, such as xylene or toluene, or citric acid may be used as a coating material for coating organic materials on the surface of the conductive particles.

It is preferable that the diameter of the conductive particles be greater than or equal to 5 nm and less than or equal to 0.1 μm. If the diameter of the conductive particles is greater than 0.1 μm, clogging may occur in a nozzle of the droplet discharge head. In addition, if the diameter of the conductive particles is less than 5 nm, the volume ratio of the coating material to the conductive particles becomes large, and the ratio of an organic material in an obtained film becomes excessive.

It is preferable that the dispersion medium of liquid containing the conductive particles have a vapor pressure at a room temperature greater than or equal to 0.001 mmHg and less than or equal to 200 mmHg (greater than or equal to about 0.133 Pa and less than or equal to 26600 Pa). If the vapor pressure is greater than 200 mmHg, the dispersion medium is rapidly vaporized after discharge, and it becomes difficult to form a good film. In addition, it is more preferable that the dispersion medium have a vapor pressure greater than or equal to 0.001 mmHg and less than or equal to 50 mmHg (greater than or equal to about 0.133 Pa and less than or equal to 6650 Pa). If the vapor pressure is greater than 50 mmHg, when droplets are discharged using an ink-jet method, clogging in a nozzle caused by drying may occur easily. Meanwhile, if the dispersion medium has a vapor pressure less than 0.001 mmHg, drying is performed late, and the dispersion medium easily remains in the film, and it is difficult to obtain a good conductive film after the following heat/light treatment.

The dispersion medium is not particularly limited, but any dispersion medium may be used, if it can disperse the conductive particles and does not cause cohesion. For example, other than water, alcohols such as methanol, ethanol, propanol, or butanol; hydrocarbon compounds, such as n-heptane, n-octane, decane, toluene, xylene, cymene, durene, indene, dipentene, tetrahydronaphthalene, decahydronaphthalene, and cyclohexylbenzene; ether compounds such as ethylene glycol dimethyl ether, ethylene glycol diethyl ether, ethylene glycol methyl ethyl ether, diethylene glycol dimethyl ether, diethylene glycol diethyl ether, diethylene glycol methylethyl ether, 1,2-dimethoxyethane, bis (2-methoxyethyl)ether, and p-dioxane, and polar compounds such as propylene carbornate, γ-butyrolatone, N-methyl-2-pyrrolidone, dimethylformamide, dimethyl sulfoxide, and cyclohexanone may be used as the dispersion medium. Among the above dispersion mediums, due to the dispersibility of particles, stability of a dispersion solution, and easy application to an ink-jet method, water, alcohols, hydrocarbon compounds, and ether compounds are preferably used, and more preferably, water and hydrogen compounds are used. Single compounds may be only used as the dispersion medium, or two or more mixtures may be used as the dispersion medium.

The concentration of a dispersoid when the conductive particles are dispersed in the dispersion medium, is greater than or equal to 1 mass percent or less than or equal to 80 mass percent. The concentration of the dispersoid is adjusted according to the thickness of a predetermined conductive film. In addition, if the concentration of the dispersoid exceeds 80 mass percent, cohesion may easily occur, and it is difficult to obtain a uniform film.

It is preferable that the surface tension of the dispersion solution of the conductive particles be greater than or equal to 0.02 N/m and less than or equal to 0.07 N/m. When droplets are discharged using the ink-jet method, if the surface tension is less than or equal to 0.02 N/m, the wettability of an ink composition on a nozzle surface increases. Therefore, curved flight easily occurs. If the surface tension exceeds 0.07 N/m, the shape of a meniscus at a nozzle tip is not stabilized. Therefore, it is difficult to control the discharge amount of droplets or the discharge timing of droplets.

In order to adjust the surface tension, a small amount of a surface tension regulator, such as a fluorine system, a silicon system, or a nonionic system, is added to the dispersion solution within the range that does not lower a contact angle with a substrate greatly.

The nonionic surface tension regulator is helpful to improve wettability of the liquid to the substrate, to improve leveling property of a film, and to prevent the occurrence of fine unevenness of the film. If necessary, the dispersion solution may include organic compounds, such as alcohols, ether, ester, and ketone.

It is preferable that the viscosity of the dispersion solution be greater than or equal to 1 mPa.s and less than or equal to 50 mPa.s. When a liquid material is discharged as the droplets using the ink-jet method, if the viscosity of the dispersion solution is less than 1 mPa.s, the peripheral portion of a nozzle is easily contaminated by the outflow of ink, and if the viscosity of the dispersion solution is more than 50 mPa.s, the frequency of clogging in a nozzle opening is increased, and it is difficult to discharge droplets smoothly.

Surface Treatment Step

Next, surface treatment steps S2 and S3 shown in FIG. 1 will be described. In the surface treatment steps, the surface of a substrate for forming conductive film wiring is treated to have a lyophobic property against a liquid material (step S2).

Specifically, surface treatment is performed on the substrate so that a predetermined contact angle with respect to the liquid material containing conductive particles is greater than or equal to 60 deg, and preferably, greater than or equal to 90 deg and less than or equal to 110 deg. For example, a method of forming a self-organized film on the surface of a substrate and a plasma treatment method may be used as a method of controlling a lyophobic property (wettability) of the surface.

In the method of forming a self-organized film, the self-organized film formed of an organic molecular film is formed on the surface of a substrate on which conductive film wiring is to be formed. The organic molecular film for treating the surface of the substrate includes a functional group that can be combined with the substrate, a functional group called a lyophilic or lyophobic group and formed at a side opposite to the side in which the functional group is formed, which reforms a surface property (controlling a surface energy) of the substrate, and straight carbon chains used to combine these functional groups or partially-branched carbon chains. Thus, the organic molecular-film is combined with the substrate and self organized so that a molecular film such as a monomolecular film is formed.

Here, the self-organized film is formed of a connective functional group that reacts to constituent atoms of a base layer of the substrate, and other linear chain molecule and is formed by aligning compounds having a very high alignment property by an interaction between the linear chain molecules. Since the self-organized film is formed by aligning single molecules, the layer thickness thereof can be made very small, and the self-organized film becomes a uniform film at a molecular level. In other words, since the same molecules are placed on the surface of the film, uniformity and excellent lyophobic property or lyophilic property can be given to the surface of the film.

Fluoroalkylsilane is used as the compounds having the very high alignment property, and each compound is aligned so that a fluoroalkyl group is placed on the surface of the film. As a result, the self-organized film is formed, and a uniform lyophobic property is given to the surface of the film.

Fluoroalkylsilane (hereinafter, referred to as FAS) such as (heptadecafluoro-1,1,2,2-tetrahydrodecyl) triethoxysilane, (heptadecafluoro-1,1,2,2-tetrahydrodecyl) trimethoxysilane, (heptadecafluoro-1,1,2,2-tetrahydrodecyl) trichlorosilane, (tridecafluoro-1,1,2,2-tetrahydrooctyl) triethoxysilane, (tridecafluoro-1,1,2,2-tetrahydrooctyl) trimethoxysilane, (tridecafluoro-1,1,2,2-tetrahydrooctyl) trichlorosilane, and trifluoropropyltrimethoxysilane, may be used as compounds to form the self-organized film. Single compounds may be used, or two or more compounds may be combined with one another. In addition, through the use of FAS, an adhering property with the substrate and a good lyophobic property can be obtained.

In general, FAS is represented by a structural formula RnSiX(4−n). Here, n is an integer greater than or equal to 1 and less than or equal to 3, and X is a hydrolysis group such as a methoxy group, an ethoxy group, and halogen atoms. In addition, R is a fluoroalkyl group and has a structure of (CF3)(CF2)x(CH2)y (where x is an integer greater than or equal to 0 and less than or equal to 10, and y is an integer greater than or equal to 0 and less than or equal to 4). When a plurality of R or X are combined with Si, R or X may be respectively the same as or different from each other. The hydrolysis group represented by X forms silanol by hydrolysis, reacts to a hydroxyl group of the base of a substrate (glass or silicon), and is combined with the substrate by siloxane combination. Meanwhile, since R has a fluoro group, such as CF3, on the surface of the substrate, the base surface of the substrate is reformed on an un-wet surface (having a low surface energy).

The self-organized film formed of an organic molecular film is formed on the substrate by putting the raw material compounds and the substrate in the same airtight container and leaving them alone at a room temperature for two or three days. In addition, the airtight container is maintained at 100° C. for about three hours. The above method is a method of forming the self-organized film from vapor, but the self-organized film may be formed from liquid. For example, the self-organized film is formed on the substrate by dipping the substrate in a solution including raw material compounds and cleaning and drying the substrate. In addition, it is preferable that before forming the self-organized film, previous treatment of the surface of the substrate is performed by irradiating the surface of the substrate with ultraviolet light or cleaning the substrate using a solvent.

After FAS treatment, if necessary, lyophobic property lowering treatment is performed (step S3) so that the surface of the substrate has a desire lyophobic property. In other words, when FAS treatment is performed as lyophobic treatment, the action of the lyophobic property is so strong that a substrate and a film pattern W formed on the substrate may be easily peeled off. In this case, treatment for lowering (adjusting) the lyophobic property is performed. Ultraviolet (UV) irradiation treatment having a wavelength of about 170 to 400 nm may be used as treatment for lowering the lyophobic property. By irradiating the substrate with ultraviolet rays having a predetermined power for a predetermined period of time, the lyophobic property of the substrate on which FAS treatment is performed is lowered, and the substrate has a desired lyophobic property. Alternatively, by exposing the substrate to an ozone atmosphere, the lyophobic property of the substrate can be controlled.

Meanwhile, in the plasma treatment method, the plasma-irradiation is performed on the substrate under atmospheric pressure or in a vacuum state. A variety of gases may be selected as gases used in plasma treatment in consideration of the surface material of the substrate on which conductive film wiring is to be formed. For example, 4 fluoromethane, perfluorohexane, or perfluorodecane may be used as treatment gases.

In addition, treatment for processing the surface of the substrate with a lyophobic property may be performed by attaching a film with a desired lyophobic property, for example, a 4 fluoroethylene-processed polyimide film to the surface of the substrate. In addition, a polyimide film having a high lyophobic property may be used as the substrate.

Intermediate Drying Step

Next, an intermediate drying step S5 of FIG. 1 will be described. In the intermediate drying step (heat/light treatment step), a dispersion medium or a coating material contained in droplets arranged on a substrate is removed. In other words, the dispersion medium of a liquid material for forming a conductive film arranged on the substrate needs to be completely removed so as to improve electrical contact between particles. In addition, when the surface of conductive particles is coated with a coating material such as an organic matter so as to improve the dispersibility thereof, the coating material needs to be removed.

In general, heat/light treatment is performed in the air, and if necessary, in an inert gas atmosphere, such as nitrogen, argon, or helium. The temperature required for headlight treatment is properly determined in consideration of the boiling point (vapor pressure) of the dispersion medium, the type or pressure of an atmosphere gas, thermal behavior such as dispersibility or an oxidative of particles, the existence or amount of a coating material, and a heat-resistant temperature of a material. For example, in order to remove the coating material formed of an organic material, the substrate needs to be baked at a high temperature of about 300° C. In addition, in the case of using a substrate formed of plastics, it is preferable that the substrate be baked at over a room temperature and at a temperature less than or equal to 100° C.

A heating apparatus, such as a hot plate or an electric furnace may be used in the heat treatment. Lamp annealing may be used in the light treatment. A light source of light used in lamp annealing is not limited particularly, but an infrared lamp, a xenon lamp, a YAG laser, an argon laser, a carbonic acid gas laser, or an excimer laser such as XeF, XeCl, XeBr, KrF, KrCl, ArF, or ArCl, may be used as the light source. In general, these light sources having an output greater than or equal to 10 W and less than or equal to 5000 W are used, but in the present embodiment, light sources having greater than or equal to 100 W and less than or equal to 1000 W may be well used. Electrical contact between particles is obtained by the heat/light treatment, and a dispersion solution is changed into a conductive film.

In addition, in this case, even though there is no difficulty in increasing the degree of heating or light scanning for removing the dispersion medium and changing the dispersion solution into the conductive film, it is sufficient to remove some of the dispersion medium sufficiently. For example, in the case of heat treatment, in general, heating may be performed at about 100° C. for a few minutes. In addition, drying treatment may be simultaneously performed with discharge of the liquid material. For example, the substrate is heated in advance, or the dispersion medium having a low boiling point is used with cooling of a droplet discharge head so that drying of droplets can be performed immediately after the droplets are arranged on the substrate.

Through the above-described steps, a linear conductive film pattern is formed on the substrate. In the method of forming conductive film wiring of the present embodiment, even though there is a limitation to the line width of a linear pattern that can be formed at one time, a plurality of linear patterns are integrated with each other, and the line width can be enlarged. Therefore, a conductive film pattern whose electrical conductivity is good and in which a disconnection or short circuit of a wiring portion hardly occur, can be formed.

Pattern Forming Apparatus

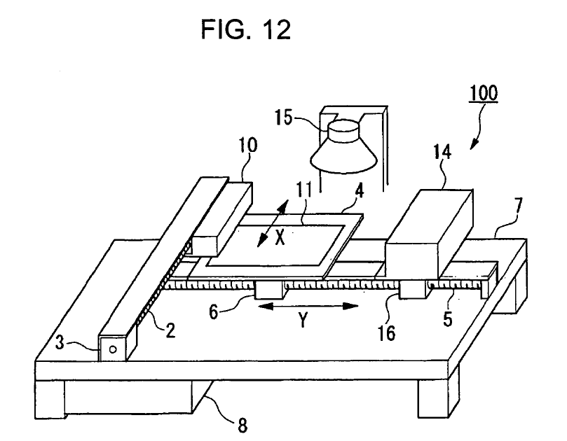

Next, an example of a pattern forming apparatus according to the present invention will be described. FIG. 12 is a schematic perspective view of a pattern forming apparatus according to an embodiment of the present invention. As shown in FIG. 12, a pattern forming apparatus 100 includes a droplet discharge head 10, an X-direction guide shaft 2 for driving the droplet discharge head 10 in an X-direction, an X-direction driving motor 3 for rotating the X-direction guide shaft 2, a mount 4 for mounting a substrate 11 thereon, a Y-direction guide shaft 5 for driving the mount 4 in a Y-direction, a Y-direction driving motor 6 for rotating the Y-direction guide shaft 5, a cleaning mechanism 14, a heater 15, and a controller 8 for controlling the elements. The X-direction guide shaft 2 and the Y-direction guide shaft 5 are fixed on a base 7. In addition, in FIG. 12, even though the droplet discharge head 10 is arranged to be perpendicular to an advancing direction of the substrate 11, the angle of the droplet discharge head 10 may be adjusted so that the droplet discharge head 10 may intersect the advancing direction of the substrate 11. In this way, the pitch between nozzles can be adjusted by adjusting the angle of the droplet discharging head 10. In addition, the distance between a nozzle surface and the substrate 11 can be arbitrarily adjusted.

The droplet discharge head 10 discharges a liquid material formed of a dispersion solution containing conductive particles through a discharge nozzle and is fixed on the X-direction guide shaft 2. The X-direction driving motor 3 is a stepping motor, and if a driving pulse signal in an X-axis direction is supplied from the controller 8 to the X-direction driving motor 3, the X-direction driving motor 3 rotates the X-direction guide shaft 2. By rotation of the X-direction guide shaft 2, the droplet discharge head 10 moves in the X-axis direction with respect to the base 7.

Droplet discharge methods may include a variety of well-known techniques such as a piezo-method of discharging ink using a piezo-element that is a piezoelectric element, and a bubble method of discharging a liquid material through bubbles generated from the heated liquid material. In the piezo-method, since heat is not applied to the liquid material, the composition of the material is not affected by the piezo-method. In addition, because of a high degree of freedom in selection of the liquid material and good control of the droplets, the piezo-method is used in the present embodiment.

The mount 4 is fixed on the Y-direction guide shaft 5, and Y-direction driving motors 6 and 16 are connected to the Y-direction guide shaft 5. The Y-direction driving motors 6 and 16 are stepping motors, and if a driving pulse signal in a Y-axis direction is supplied from the controller 8 to the Y-direction driving motors 6 and 16, the Y-direction driving motors 6 and 16 rotate the Y-direction guide shaft 5. By rotation of the Y-direction guide shaft 5, the mount 4 moves in the Y-axis direction with respect to the base 7. The cleaning mechanism 14 cleans the droplet discharge head 10 and prevents clogging of a nozzle. The cleaning mechanism 14 moves along the Y-direction guide shaft 5 by the Y-direction driving motor 16 during cleaning. The heater 15 heats the substrate 11 using heating means, such as lamp annealing, performs vaporization/drying of discharged liquid on the substrate 11, and performs heat treatment for changing a dispersion solution into a conductive film.

In the pattern forming apparatus 100 according to this embodiment, by relatively moving the substrate 11 and the droplet discharge head 10 by means of the X direction driving motor 3 and the Y direction driving motor 6 while discharging the liquid material from the droplet discharge head 10, the liquid material is arranged on the substrate 11. The amount of droplets discharged from each nozzle of the droplet discharge head 10 is controlled by means of a voltage supplied to the piezoelectric element from the control unit 8. Further, the pitch of the droplets arranged on the substrate 11 is controlled by means of the relative speed and an arrangement frequency from the droplet discharge head 10 (a frequency of the driving voltage to the piezoelectric element). Furthermore, the position at which the arrangement of the droplets on the substrate 11 is started is controlled by means of the direction of the relative movement and a timing control of the arrangement start of the droplets from the droplet discharge head 10, etc. during the relative movement. As a result, the conductive film patterns for the wiring described above are formed on the substrate 11.

Electro-optical Device

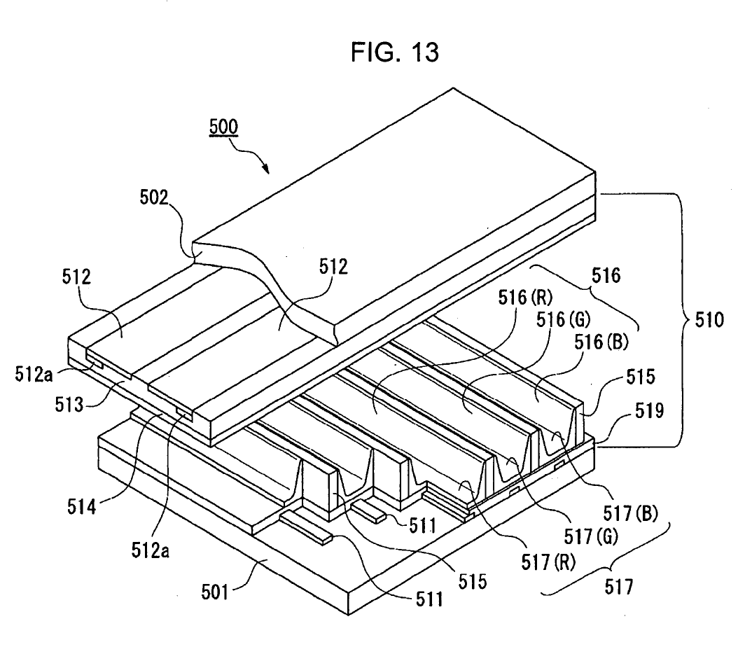

Next, a plasma display device as an example of an electro-optical device according to the present invention will be described. FIG. 13 is an exploded perspective view of a plasma display device 500 according to the present embodiment. The plasma display device 500 includes substrates 501 and 502 arranged to be opposite to each other, and a discharge display unit 510 formed therebetween. The discharge display unit 510 is formed of a plurality of discharge chambers 516. Three discharge chambers 516, such as a red discharge chamber 516(R), a green discharge chamber 516(G), and a blue discharge chamber 516(B), of the plurality of discharge chambers 516 are arranged to form one pixel.

Address electrodes 511 are formed on the top face of the substrate 501 in a stripe shape at predetermined intervals, and a dielectric layer 519 is formed to cover the address electrodes 511 and the top face of the substrate 501.

Partition walls 515 are formed on the dielectric layer 519 to be positioned between address electrodes 511, 511 and run along each address electrode 511. Each partition wall 515 includes a partition portion adjacent to the widthwise right and left sides of the address electrode 511 and a partition portion that extends in the direction perpendicular to the address electrode 511. In addition, a discharge chamber 516 is formed to correspond to a rectangular region partitioned by the partition wall 515. In addition, a fluorescent material 517 is arranged inside the rectangular region partitioned by the partition wall 515. The fluorescent material 517 emits fluorescence having one of red, green, blue colors, and a red fluorescent material 517(R) is arranged at the bottom of the red discharge chamber 516(R), a green fluorescent material 517(G) is arranged at the bottom of the green discharge chamber 516(G), and a blue fluorescent material 517(B) is arranged at the bottom of the blue discharge chamber 516(B).

Meanwhile, a plurality of display electrodes 512 are formed on the substrate 502 in a stripe shape at predetermined intervals in the direction perpendicular to the previous address electrodes 511. Further, a dielectric layer 513 and a protection layer 514 formed of MgO are formed to cover the plurality of display electrodes 512. The substrate 501 and the substrate 502 are opposite to each other and are attached to each other so that the display electrodes 512 . . . are perpendicular to the address electrodes 511 . . . . The address electrodes 511 and the display electrodes 512 are connected to an AC power source (not shown). A current flows through each electrode so that the fluorescent material 517 is excited to emit light in the discharge display unit 510, thereby allowing color display.

In the present embodiment, the address electrodes 511 and the display electrodes 512 are respectively formed by the pattern forming method of FIGS. 1 to 11 using the pattern forming apparatus of FIG. 12. Therefore, troubles such as a disconnection or short circuit of each wiring, do not occur, and it is possible to manufacture it with high throughput.

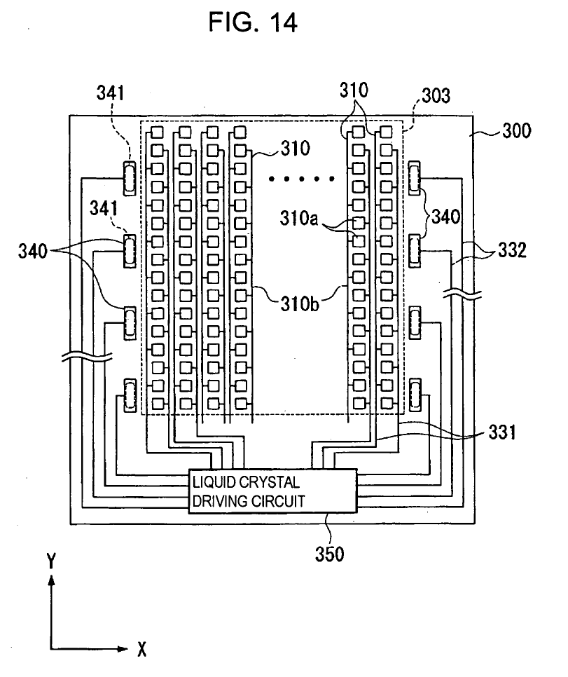

Next, a liquid crystal device as another example of the electro-optical device according to the present invention will be described. FIG. 14 shows a plan layout of a signal electrode on a first substrate of the liquid crystal device according to the present embodiment. The liquid crystal device according to the present embodiment generally includes the first substrate, a second substrate (not shown) on which-scanning electrodes are formed, and liquid crystal (not shown) enclosed between the first substrate and the second substrate.

As shown in FIG. 14, a plurality of signal electrodes 310 . . . is provided in a multi-matrix in a pixel region 303 on the first substrate 300. In particular, the respective signal electrodes 310 . . . include a plurality of pixel electrode portions 310a . . . corresponding to respective pixel and signal wiring portions 310b . . . for connecting the pixel electrode portions 310a . . . in the multi-matrix and extend in a Y-direction. In addition, reference numeral 350 denotes a liquid crystal driving circuit having a one-chip structure. The liquid crystal driving circuit 350 is connected to one end (lower side in FIG. 14) of each of the signal wiring portion 310b . . . via first pull-in wiring 331 . . . . In addition, reference numeral 340 . . . denotes up-down conducting terminals. The up-down conducting terminals 340 . . . and terminals (not shown) formed on the second substrate are connected to each other by up-down conducting materials 341 . . . . In addition, the liquid crystal driving circuit 350 and the up-down conducting terminals 340 . . . are connected to each other via a second pull-in wiring 332 . . . .

In the present embodiment, the respective signal wiring portions 310b . . . , the first pull-in wiring 331 . . . , and the second pull-in wiring 332 . . . , which are formed on the first substrate 300, are formed by the pattern forming method described referring to FIGS. 1 to 11 using the pattern forming apparatus as shown in FIG. 12. For this reason, troubles such as a disconnection or short circuit of the wiring, do not occur, and it is possible to manufacture it with high throughput. In addition, even when manufacturing a large-sized liquid crystal substrate, a wiring material can be effectively used, and costs can be reduced. In addition, a device to which the present invention can be applied is not limited to the electro-optical device, and the present invention can be applied to manufacturing other devices, such as a circuit board on which conductive film wiring is formed, or mounting wiring of a semiconductor.

Next, a liquid crystal display device as an electro-optical device according to another embodiment of the present invention will be described.

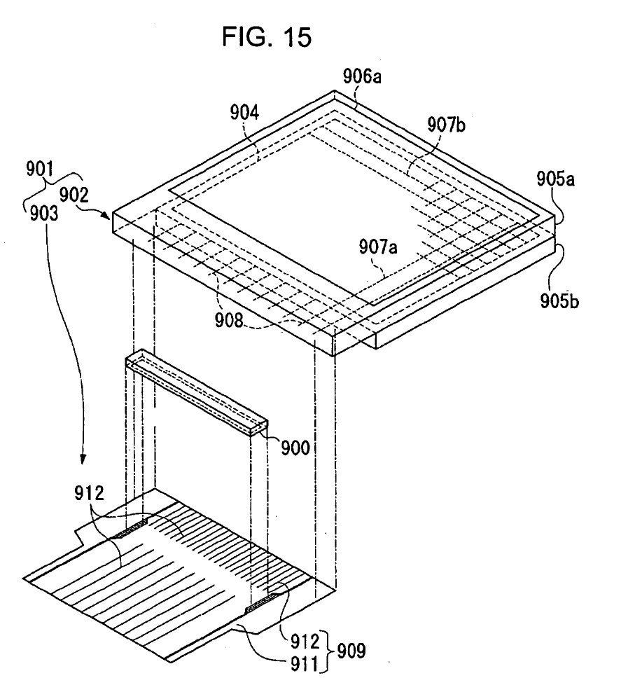

A liquid crystal device (electro-optical device) 901 of FIG. 15 largely includes a color liquid crystal panel (electro-optical panel) 902 and a circuit board 903 connected to the liquid crystal panel 902. In addition, if necessary, an illuminator, such as a backlight and other auxiliary devices, are provided in the liquid crystal panel 902.

The liquid crystal panel 902 includes a pair of substrates 905a and 905b bonded to each other using a sealing material 904, and liquid crystal is filled in a gap called a cell gap between the substrates 905a and 905b. In general, the substrates 905a and 905b are formed of a light-transmitting material, for example, glass or synthetic resin. Polarizing plates 906a and 906b are attached to the outer surfaces of the substrates 905a and 905b, respectively. In addition, the polarizing plate 906b is omitted in FIG. 15.

In addition, electrodes 907a are formed on the inner surface of the substrate 905a, and electrodes 907b are formed on the inner surface of the substrate 905b. The electrodes 907a and 907b are formed in a stripe, character, number, or other proper pattern. In addition, the electrodes 907a and 907b are formed of a light-transmitting material such as indium tin oxide (ITO). The substrate 905a includes a protruding portion with respect to the substrate 905b, and a plurality of terminals 908 are formed in the protruding portion. The terminals 908 are formed simultaneously with the electrode 907a when the electrode 907a is formed on the substrate 905a. Thus, the terminals 908 are formed of ITO, for example. The terminals 908 include terminals extending integrally from the electrodes 907a and terminals connected to the electrodes 907b via a conductive material (not shown).

A semiconductor element 900 which is a liquid crystal driving IC, is mounted in a predetermined position on a wiring board 909 of the circuit board 903. In addition, although not shown, a resistor, a capacitor, and other chip components may be mounted in the predetermined position of a portion other than a portion on which the semiconductor element 900 is mounted. The wiring board 909 is manufactured by patterning a metallic layer such as Cu formed on a base substrate 911 having flexibility, such as polyimide, and by forming a wiring pattern 912.

In the present embodiment, the electrodes 907a and 907b of the liquid crystal panel 902 and the wiring pattern 912 of the circuit board 903 are formed by the method of forming a device. According to the liquid crystal device of the present embodiment, a high-quality liquid crystal display device in which non-uniformity of electric characteristics is removed can be obtained.

According to the liquid crystal device of the present embodiment, a high-quality liquid crystal display device in which non-uniformity of electric characteristics is removed can be obtained.

In addition, the above-described example is a passive liquid crystal panel, but may be an active-matrix liquid crystal panel. In other words, a thin film transistor (TFT) is formed on one substrate, and a pixel electrode is formed on each TFT. In addition, wiring (gate wiring and source wiring) electrically connected to each TFT can be formed using an ink-jet technique as described above. Meanwhile, a counter electrode is formed on a counter substrate. The present invention can be applied to the active-matrix liquid crystal panel.

Next, a field emission display (FED) having a field emission element (electron emission element) of an electro-optical device according to another embodiment of the present invention will be described.

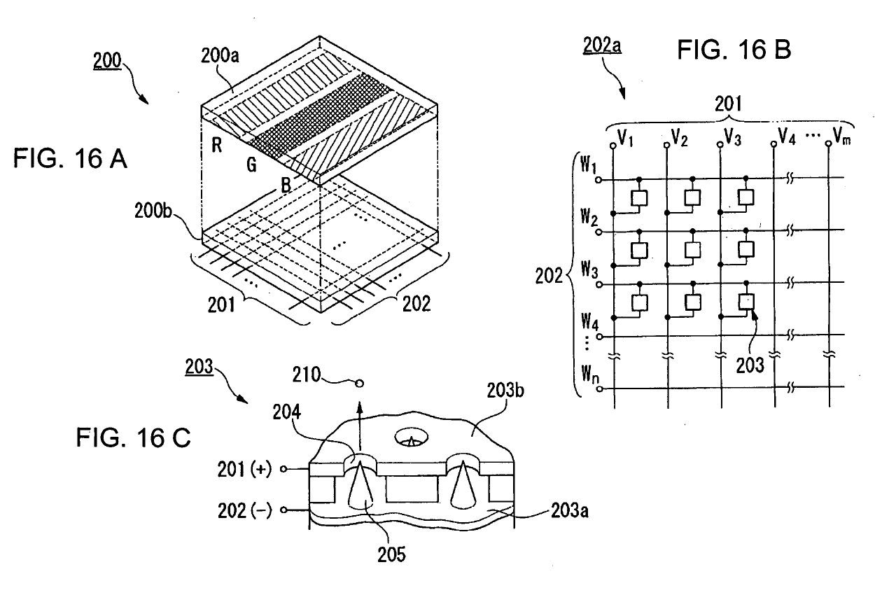

FIGS. 16A-C are views illustrating the FED. FIG. 16(a) schematically shows the arrangement of a cathode substrate and an anode substrate that constitute the FED. FIG. 16(b) is a mimetic diagram of a driving circuit of the cathode substrate of the FED. FIG. 16(c) is a perspective view of a main part of the cathode substrate.

As shown in FIG. 16(a), an FED (electro-optical device) 200 has a structure in which the cathode substrate 200a and the anode substrate 200b are arranged opposite to each other. As shown in FIG. 16(b), the cathode substrate 200a includes a gate line 201, an emitter line 202, and a field emission element 203 connected to the gate line 201 and the emitter line 202. In other words, the cathode substrate 200a becomes a so-called simple matrix driving circuit. Gate signals V1, V2, . . . , and Vm are supplied to the gate line 201, and emitter signals W1, W2, . . . , and Wn are supplied to the emitter line 202. In addition, the anode substrate 200b includes a fluorescent material formed of R, G, and B and has a property in which electrons hit a corresponding fluorescent material to emit light.

As shown in FIG. 16(c), the field emission element 203 includes an emitter electrode 203a connected to the emitter line 202 and a gate electrode 203b connected to the gate line 201. Further, the emitter electrode 203a has a protrusion called an emitter tip 205 whose diameter becomes smaller from the emitter electrode 203a to the gate electrode 203b, and a hole 204 is formed in the gate electrode 203b in a position corresponding to the emitter tip 205, and a tip of the emitter tip 205 is arranged in the hole 204.

With regard to the FED 200, gate signals V1, V2, . . . , and Vm of the gate line 201 and emitter signals W1, W2, . . . , and Wn of the emitter line 202 are controlled so that a voltage is supplied between the emitter electrode 203a and the gate electrode 203b, an electron 210 moves toward the hole 204 from the emitter tip 205 by electrolytic action, and the electron 210 is emitted from the tip of the emitter tip 205. Here, since the corresponding electron 210 is hit on the fluorescent material of the anode substrate 200b to emit light, a desired FED 200 can be driven.

With regard to the FED having the above structure, for example, the emitter electrode 203a or the emitter line 202, or the gate electrode 203b or the gate line 201 is formed by the method of forming a device.

According to the FED of the present embodiment, a high-quality FED in which non-uniformity of electric characteristics is removed can be obtained.

Electronic Apparatus

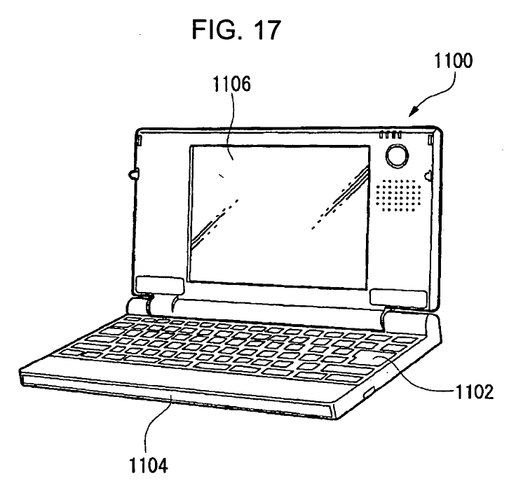

Next, an example of an electronic apparatus according to the present invention will be described. FIG. 17 is a perspective view showing the structure of a mobile personal computer (information processing device) having a display device according to the above-described embodiment. In FIG. 15, the personal computer 1100 includes a main body 1104 having a keyboard 1102 and a display device unit having the above-described electro-optical device 1106. Thus, an electronic apparatus having a high luminous efficiency and a bright display unit can be provided.

In addition to the above-described example, as other examples, the electronic apparatus includes a mobile telephone, a wrist watch electronic apparatus, a liquid crystal TV, a video tape recorder of view finder type or monitor direct-viewing type, a car navigation apparatus, a pager, an electronic note, an electronic calculator, a word processor, a workstation, a mobile phone, a POS terminal, an electronic paper, and an apparatus having a touch panel. The electro-optical device according to the present invention can also be applied to a display unit of the electronic apparatus. In addition, the electronic apparatus according to the present embodiment includes an electronic apparatus having other electro-optical devices having a liquid crystal device, an organic electroluminescent display device, and a plasma display device.

As described above, although preferred embodiments of the present invention has been particularly shown and described with reference to the accompanying drawings, it goes without saying that the present invention is not limited to the embodiments as shown and described. Various shapes or combinations of the respective elements as shown in the above-described embodiments are just examples, and various changes may be made depending on design requirements without departing from the spirit of the present invention.

What is claimed is:

1. A pattern forming method of forming film patterns by arranging droplets of a liquid material on a substrate, comprising:
defining a plurality of pattern forming areas, in which the film patterns are to be formed, on the substrate, the areas including:
a first pattern forming area in which a film pattern is to be formed from a side thereof; and
a second pattern forming area in which a film pattern is to be formed from the center thereof; and
arranging the droplets in each of the first and second pattern forming areas to form the film patterns.

2. The pattern-forming method according to claim 1, wherein the method comprises a step of substantially simultaneously arranging the droplets in the first and second pattern forming areas.

3. The pattern forming method according to claim 1,
wherein the method comprises a step of arranging the droplets in only one of the first and second pattern forming areas.

4. The pattern forming method according to claim 1,
wherein in the first pattern forming area, the side is first formed and then the central portion is formed, and in the second pattern forming area, the central portion is first formed and then the side is formed.

5. The pattern forming method according to claim 1,
wherein a plurality of discharge portions for arranging the droplets are provided corresponding to the first and second pattern forming areas, and the droplets are arranged while moving the discharge portions in the direction in which the pattern forming areas are arranged.

6. The pattern forming method according to claim 1, the method further comprising:
a step of forming one side of a first film pattern to be formed in the first pattern forming area;
a step of forming a central portion of a second film pattern to be formed in the second pattern forming area at the same time as forming the other side of the first film pattern; and
a step of forming one of one side and the other side of the second film pattern at the same time as forming a central portion of the first film pattern.

7. A pattern forming method of forming film patterns by arranging droplets of a liquid material on a substrate, the method comprising, when a plurality of the film patterns are arranged and formed on the substrate:
a first step of forming a first area of a first film pattern of the plurality of film patterns;
a second step of forming a first area of a second film pattern at the same time as forming a second area of the first film pattern; and
a third step of forming a second area of the second film pattern at the same time as forming a third area of the first film pattern.

8. The pattern forming method according to claim 7,
wherein the method further comprises a fourth step of forming a third area of the second film pattern after the third step.

9. The pattern forming method according to claim 7,
wherein the liquid material comprises conductive particles.

10. A pattern forming apparatus comprising:
a droplet discharge device for arranging droplets of a liquid material on a substrate and that forms film patterns by using the droplets,
wherein the droplet discharge device forms a first film pattern to be formed in a first pattern forming area of a plurality of pattern forming areas which are previously arranged and defined on the substrate and in which the film patterns are to be formed, from a side thereof, and forms a second film pattern to be formed in a second pattern forming area from a central portion thereof.

11. A pattern forming apparatus comprising:
a droplet discharge device for arranging droplets of a liquid material on a substrate and that forms a plurality of film patterns on the substrate by using the droplets,
wherein the droplet discharge device first forms a first area of a first film pattern, forms a first area of a second film pattern at the same time as forming a second area of the first film pattern, and then forms a second area of the second film pattern at the same time as forming a third area of the first film pattern.

12. A method of manufacturing a device having wiring patterns, the method comprising:
a material arranging step of forming the wiring patterns by arranging droplets of a liquid material in each of a plurality of pattern forming areas which are arranged and defined on the substrate and in which the wiring patterns are to be formed,
wherein in the material arranging step, a first pattern forming area in which a wiring pattern is to be formed from one side thereof and a second pattern forming area in which a wiring pattern is to be formed from the center thereof are defined in the plurality of pattern forming areas, and the droplets are arranged in each of the first and second pattern forming areas to form the wiring patterns.

13. A method of manufacturing a device having wiring patterns, the method comprising:
a material arranging step of forming a plurality of wiring patterns by arranging droplets of a liquid material on the substrate,
wherein the material arranging step comprises:
a first step of forming a first area of a first wiring pattern of the plurality of wiring patterns;
a second step of forming a first area of a second wiring pattern at the same time as forming a second area of the first wiring pattern; and
a third step of forming a second area of the second wiring pattern at the same time as forming a third area of the first wiring pattern.

14. Conductive film wiring formed using the pattern forming apparatus according to claim 10.

15. An electro-optical device comprising conductive film wiring according to claim 14.

16. An electronic apparatus comprising an electro-optical device according to claim 15.
